(19) United States
(12) Patent Application Publication
(10) Pub. No.: US 2012/0036352 A1
(43) Pub. Date: Feb. 9, 2012

(54) Anonymization of Personal Data

(76) Inventors: Tom C. Tovar, San Francisco, CA (US); Gopala Tumuluri, San Jose, CA (US); Hongche Liu, Fremont, CA (US); Rujul Patel, San Jose, CA (US)

(21) Appl. No.: 13/181,440

(22) Filed: Jul. 12, 2011

Related U.S. Application Data
(60) Provisional application No. 61/363,334, filed on Jul. 12, 2010.

(51) Int. Cl. H04L 9/00; G06F 15/16

(52) U.S. Cl. 713/153; 713/150

(57) ABSTRACT

A method for anonymization of personal data is provided for protecting the privacy of a user while sharing user information with a third party. The method includes receiving from a user a domain name address associated with an intended website and an Internet Protocol (IP) address associated with the user and determining that the domain name address is an invalid domain name. The method may further include encrypting the IP address associated with the user by translating the IP address into a unique identifier, with the encryption being a one-way hashing process, and then sending the unique identifier and the invalid domain name address to the third party. The method may further include receiving, from the third party, the unique identifier and a third party content, with the third party content being based on the invalid domain name; decrypting the unique identifier by translating the unique identifier back into the IP address, associating the third party content with the IP address, and based on the IP address, providing the third party content to the user.

### CROSS-REFERENCE TO RELATED APPLICATIONS

This nonprovisional patent application claims the priority benefit of U.S. Provisional Application No. 61/363,334 filed on Jul. 12, 2010, titled “Anonymization of Personal Data,” which is hereby incorporated by reference in its entirety.

### FIELD OF THE INVENTION

This application relates generally to data processing and, more specifically, to a redirection service that ensures anonymization of personal data.

### DESCRIPTION OF RELATED ART

When a user mistypes a Uniform Resource Locator (URL) in an Internet browser and the mistyped URL refers to a server name that is not associated with a valid server, a Domain Name System (DNS) error will appear. The typo may create an opportunity for an Internet Service Provider (ISP) to provide additional value added services based on the analysis of the mistyped URL. In some circumstances, this may involve sharing user information with third parties, including sharing an Internet Protocol (IP) address associated with the user system.

The IP address, however, may be considered Personally Identifiable Information (PII), information that can be used to uniquely identify, contact, or locate the user or can be used with other sources to uniquely identify the user. The Internet has made it easier to collect PII, leading to a profitable market in collecting and reselling PII. However, criminals can use PII to stalk a user or to steal a user's identity. In response to these threats, some jurisdictions enacted a series of legislation and rules to limit the distribution and accessibility of IP addresses. Some of this legislation prohibits ISPs from sharing IP addresses with parties without the user's consent.

For example, rules established by the German Telemedia Act (Telemediengesetz—TMG) protect against dissemination of Personal Data (PD). Without anonymization of PD in ISP networks, web error redirection services may not comply with German law or other similar laws in other jurisdictions.

### SUMMARY OF THE CLAIMED INVENTION

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

A method for anonymization of personal data includes receiving, from the user, a domain name address associated with an intended website and an IP address associated with the user. The request may be received within an ISP network associated with the user. The third party may be located outside the ISP network.

The method further includes determining that the domain name address is an invalid domain name, encrypting the IP address associated with the user by translating the IP address into a unique identifier, with the encryption being a one-way hashing process, sending the unique identifier and the invalid domain name address to the third party, receiving, from the third party, the unique identifier and a third party content, with the third party content being based on the invalid domain name, decrypting the unique identifier by translating the unique identifier back into the IP address and based on the IP address, providing to the user with the third party content.

In further exemplary embodiments, modules, subsystems, or devices can be adapted to perform the recited steps. Other features and exemplary embodiments are described below.

### BRIEF DESCRIPTION OF THE DRAWINGS

Embodiments are illustrated by way of example and not limitation in the figures of the accompanying drawings, in which like references indicate similar elements.

FIG. 1 is a block diagram of an environment within which systems and methods for anonymization of personal data may be implemented.

FIG. 2 is a block diagram of a compliance server.

FIG. 3 illustrates a flow chart of a method for anonymization of personal data.

FIG. 4 is a block diagram of a Domain Name System (DNS) resolver environment.

FIG. 5 is a computing system that may be used to implement methods for anonymization of personal data.

### DETAILED DESCRIPTION

Methods and systems for anonymization of personal data may allow an ISP to provide additional value added services while ensuring compliance with the laws. For example, a user may attempt to access a certain website but mistypes the URL. Normally, the user will get a nonexistent page error. This may create a valuable opportunity for the ISP to provide additional value added service. Such service may be provided by a third party. The ISP may forward the mistyped URL to a third party so that the third party analyzes the mistyped URL to determine the intended website. Based on this information, the third party may provide additional value added services to the user.

However, this approach involves sharing user IP addresses with a third party. As already mentioned above, many jurisdictions consider an IP address to be PII and prohibit sharing of such information with third parties.

The systems and methods described herein may allow the ISP to provide third party content to the user in response to mistyped domain names without sharing user IP address. In one embodiment, a user request may be intercepted by the ISP. The ISP may determine by querying a DNS server that the domain name is invalid. Thereafter, the IP address associated with the user may be encrypted with a one-way hash technique to create a unique identifier. For example, MD5 hashing algorithm to produce a 128-bit hash value may be used. Once converted to a hash value, subscriber IP addresses (or any other Personal Data) cannot be linked or traced back to the requestor, and the mistyped domain name can sent to a third party. When the third party returns third party content, the ISP can translate the unique identifier back into the IP address and build a webpage having the third party content instead of the standard nonexistent page normally provided by the browser.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

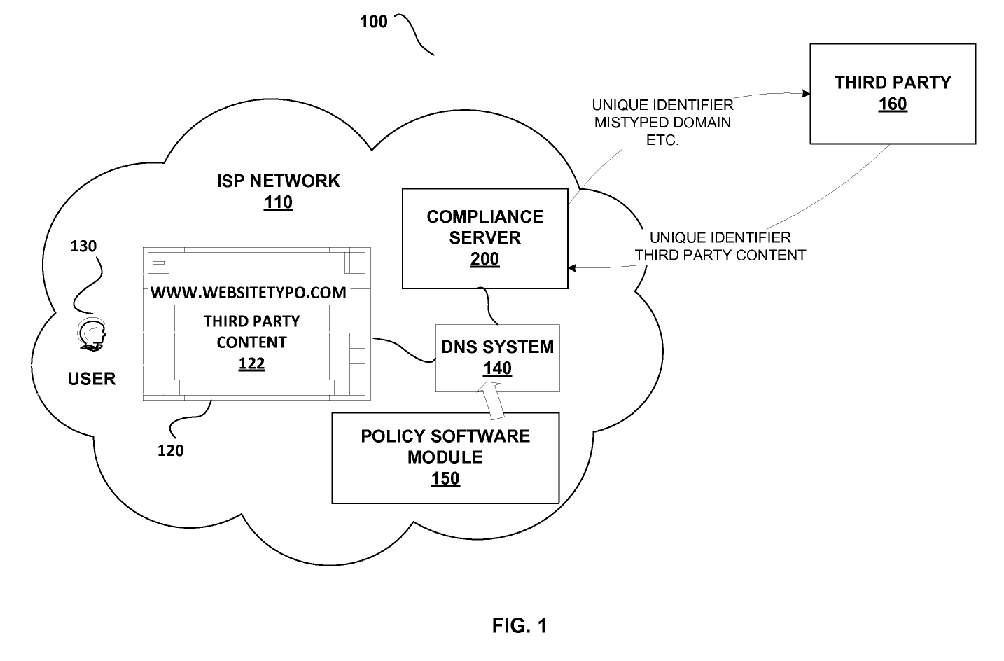

FIG. 1 is a block of environment 100, within which systems and methods for anonymization of personal data may be implemented. As shown in FIG. 1, the environment 100 may include an ISP network 110, a browser 120, a user 130, a DNS system 140, a policy software module 150, and a third party 160. The browser 120 may include third party content 122.

The DNS system 140 may cache DNS names required by the browser 120. When the user browses the Internet using the browser 120, website names are converted to IP addresses. The DNS system 140 is a DNS caching system that may feature a policy layer, security, specialized query handling, and a rich information intelligence layer. The policy layer may include the policy software module 150. These features may allow network owners to leverage the DNS system 140 for more than just mere query handling, thereby improving service quality, usefulness, and safety for users.

The DNS system 140 may secure the server, protect the network, safeguard users, enable new services, allow real time monitoring, and dynamically integrate with various hosted services. The policy software module 150 may be optimized to work in conjunction with hosted services.

The DNS system 140 may take advantage of a Hosted Network Service that provides network intelligence on demand by leveraging specific elements of an embedded Analytics System (not shown). The policy software module 150 may run on the DNS system 140 to interpret the intent of the user 130 when the user 130 enters Internet service requests into the address bar of the browser 120. The policy software module 150 may redirect users to a user-friendly search page, rather than sending a confusing and unhelpful non-existent domain response.

The user 130 may not remember the exact spelling of specific URLs. With the DNS system 140, the user 130 can simply type any name into the address name of the browser 120 and perform a search. Rather than receiving an unhelpful error page, the policy software module 150 may redirect these Internet service requests to highly relevant search pages that help get the user 130 to their intended destination. This eliminates confusion and frustration as well as the need to retype requests into a search box located elsewhere in the browser.

Thus, the policy software module 150 may interpret user entries in the address bar of the browser 120, thereby getting users to their intended destinations. When a web site name cannot be resolved, the DNS system 140 may evaluate the available website listings and other content that might match the mistyped URL and guide the user to a search results page.

A rich set of policies and configuration and exclusion rules may protect applications and the user 130 traffic from disruption. These policies may be adjusted manually by the network operator or improved dynamically by the compliance server 200. The compliance server 200 may be combined with the DNS system 140. This combination can provide filtering capabilities and adaptive learning to identify and qualify consumer generated browser typos for monetization in association with the third party 160.

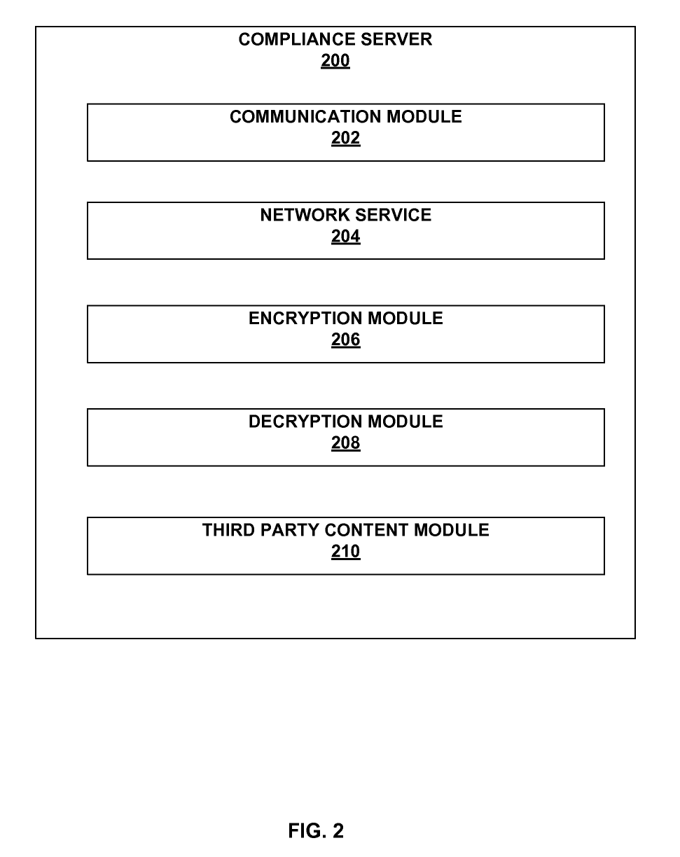

To comply with privacy legislation prohibiting sharing IP addresses with third parties, the compliance server 200 may anonymize IP addresses by encrypting them using a one-way hashing technique. The technique will ensure that the third party 160 cannot view the IP addresses associated with the mistyped domains forwarded by the compliance server 200. Instead, a unique identifier is passed with each request. The third party 160 may analyze the mistyped domain and, based on the analysis, provide the third party content 122, including commercial information (e.g., an advertisement), in response. The compliance server 200 is discussed further below with reference to FIG. 2.

FIG. 2 is a block diagram of the compliance server 200. In some example embodiments, the compliance server 200 may include a communication module 202, a network service 204, an encryption module 206, a decryption module 208, and a third party content module 210.

The communication module 202 may be configurable to receive, from the user, a domain name address associated with an intended website and an IP address associated with the user. The request may be received within the ISP network 110 associated with the user. The third party may be located outside the ISP network 110. The network service 204 may determine that the domain name address is an invalid (mistyped) domain name. Prior to passing the information to the third party 160, the encryption module 206 may encrypt the IP address associated with the user 130 by translating the IP address into a unique identifier. The encryption may be a one-way hashing process to ensure that the third party 160 does not determine the IP address.

Thereafter, the communication module 202 may send the unique identifier and the invalid domain name address to the third party 160. In response, the third party 160 may provide the communication module 202 with the third party content 122 (e.g., an advertisement) and the same unique identifier. The third party content 122 may be based on the invalid domain name. The decryption module 208 may decrypt the unique identifier by translating the unique identifier back into the IP address.

In some embodiments, the communication module 202 may provide the user 130 with an option page. The option page may allow the user 130 to opt in to receiving the third party content 122. If the user 130 agrees to receive the third party content 122, a cookie may be placed on a system associated with the user 130 for future transactions so that the user 130 will receive the third party content 122. If, on the other hand, the user opted not to receive the third party content 122, the communication module 202 may again provide the user 130 with the opt in option, or the communication module 202 may simply provide the user 130 with a non-existent page error message.

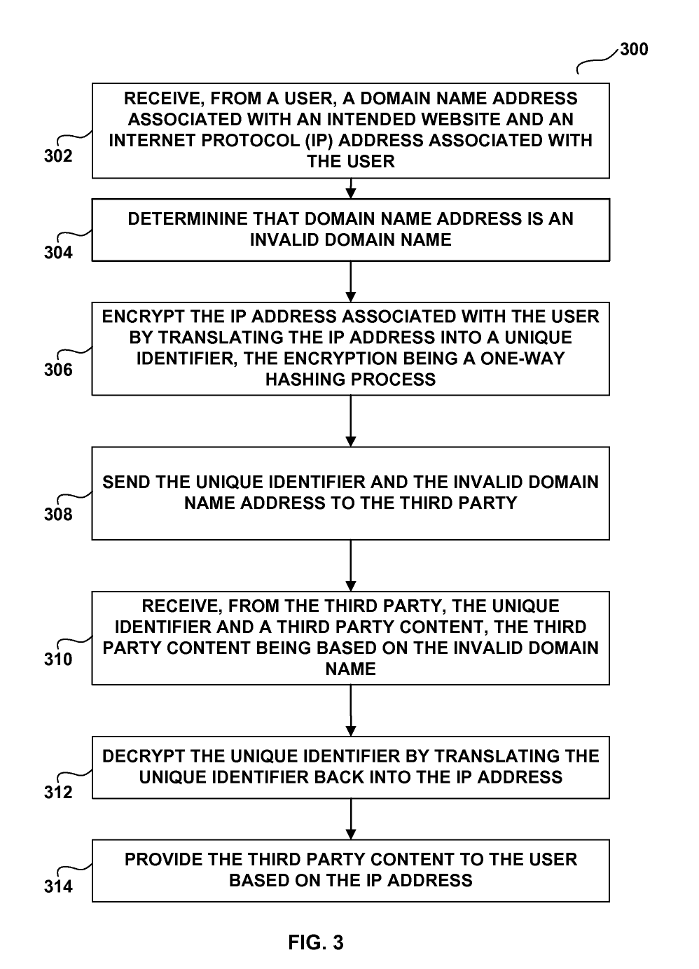

FIG. 3 illustrates a flow chart of a method 300 for protecting user privacy. The method 300 may be performed by processing logic that may comprise hardware (e.g., dedicated logic, programmable logic, microcode, etc.), software (such as run on a general-purpose computer system or a dedicated machine), or a combination of both. In one embodiment, the processing logic resides at the compliance server 200, as illustrated in FIG. 2.

The method 300 may commence at operation 302 with the communication module 202 receiving, from the user 130, a domain name address associated with an intended website and an IP address associated with the user 130. The request may be received within an ISP network 110. The third party 160 may be located outside the ISP network 110.

At operation 304, the network service 204 may determine that the domain name address is an invalid domain name. Based on the determination, at operation 306, the encryption module 206 may encrypt the IP address associated with the user 130 by translating the IP address into a unique identifier. The encryption may be a one-way hashing process. At operation 308, the communication module 202 may send the unique identifier and the invalid domain name address to the third party 160.

At operation 310, the communication module 202 may receive, from the third party 160, the unique identifier and a third party content 122, with the third party content 122 being based on the invalid domain name. At operation 312, the decryption module 208 may decrypt the unique identifier by translating the unique identifier back into the IP address. At operation 314, the communication module 202 may provide the user 130 with the third party content 122, based on the IP address.

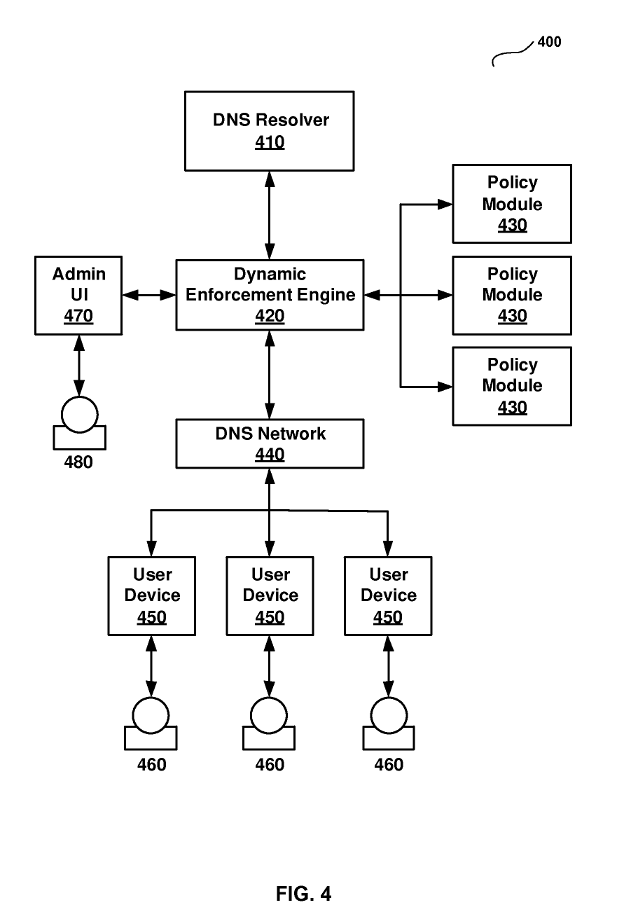

FIG. 4 illustrates an exemplary Internet service system 400, with a DNS Resolver 410, that may be utilized to support the above described systems and methods. A DNS Resolver 410 operates in conjunction with a dynamic enforcement engine 420. The dynamic enforcement engine 420 may operate in conjunction with one or more policy modules 430 to establish any applicable polices at the DNS Resolver 410 level. The content rules are applied to received user queries to determine which content the DNS network 440 delivers through various user devices 450 to the network users 460.

The dynamic enforcement engine 420 may generate its policy engine on instructions received from one or more policy modules 430. Each policy module 430 may be constructed to provide various types and levels of services to the DNS network 440. In various embodiments, a policy module 430 may be configured to handle queries directed to subjects including, but not limited to, malicious domain redirection, user access redirection, non-existent domain redirection, and data collection or analysis.

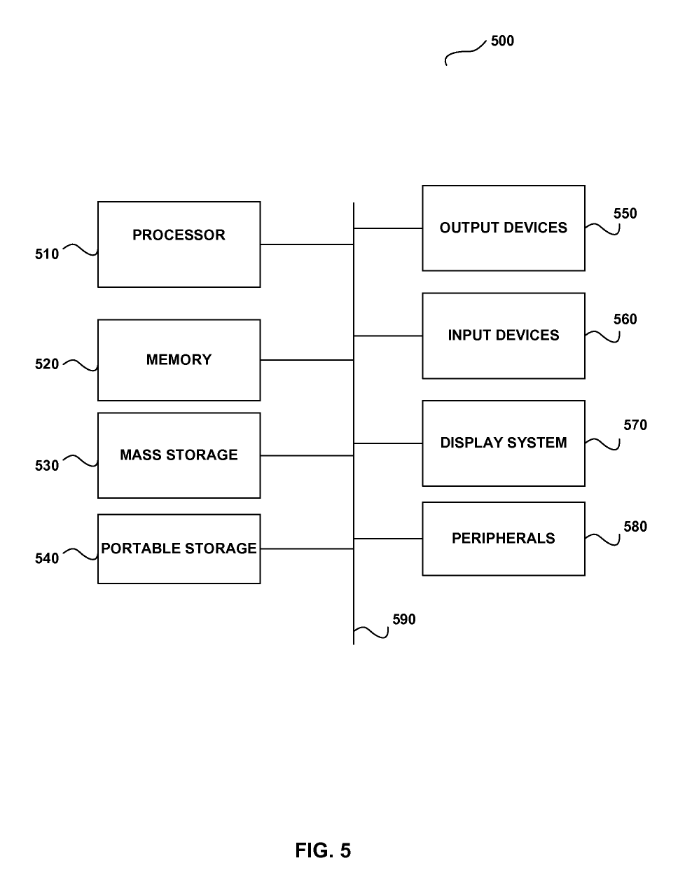

FIG. 5 illustrates an exemplary computing system 500 that may be used to implement an embodiment of the present invention. System 500 of FIG. 5 may be implemented in the context of user devices 450, DNS Resolver 410 and the like. The computing system 500 of FIG. 5 includes one or more processors 510 and main memory 520. Main memory 520 stores, in part, instructions and data for execution by processor 510. Main memory 520 may store the executable code when the system 500 is in operation. The system 500 of FIG. 5 may further include a mass storage device 530, portable storage medium drive(s) 540, output devices 550, user input devices 560, a display system 570, and other peripheral devices 580.

The components shown in FIG. 5 are depicted as being connected via a single bus 590. The components may be connected through one or more data transport means. Processor 510 and main memory 520 may be connected via a local microprocessor bus, and the mass storage device 530, peripheral device(s) 580, portable storage medium drive 540, and display system 570 may be connected via one or more input/output (I/O) buses.

Mass storage device 530, which may be implemented with a magnetic disk drive or an optical disk drive, is a non-volatile storage device for storing data and instructions for use by processor 510. Mass storage device 530 may store the system software for implementing embodiments of the present invention for purposes of loading that software into main memory 520.

Portable storage medium drive 540 operates in conjunction with a portable non-volatile storage medium, such as a floppy disk, compact disk (CD), or digital video disc (DVD), to input and output data and code to and from the computer system 500 of FIG. 5. The system software for implementing embodiments of the present invention may be stored on such a portable medium and input to the computer system 500 via the portable storage medium drive 540.

User input devices 560 provide a portion of a user interface. User input devices 560 may include an alpha-numeric keypad, such as a keyboard, for inputting alpha-numeric and other information, or a pointing device, such as a mouse, trackball, stylus, or cursor direction keys. Additionally, the system 500 as shown in FIG. 5 includes output devices 550. Suitable output devices include speakers, printers, network interfaces, and monitors.

Display system 570 may include a liquid crystal display (LCD) or other suitable display device. Display system 570 receives textual and graphical information and processes the information for output to the display device.

Peripheral device(s) 580 may include any type of computer support device to add additional functionality to the computer system. Peripheral device(s) 580 may include a modem or a router.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 may be a personal computer (PC), hand held computing device, telephone, mobile computing device, workstation, server, minicomputer, mainframe computer, or any other computing device. The computer may also include different bus configurations, networked platforms, multi-processor platforms, and so forth. Various operating systems can be used, including UNIX, Linux, Windows, Macintosh Operating System (OS), Palm OS, and other suitable operating systems.

Some of the above-described functions may be composed of instructions that are stored on storage media (e.g., a computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processors, and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a central processing unit (CPU) for execution. Such media can take many forms, including, but not limited to, non-volatile media, volatile media, and transmission media. Non-volatile media include, for example, optical or magnetic disks, such as fixed disks. Volatile media include dynamic memory, such as system Random Access Memory (RAM). Transmission media include coaxial cables, copper wire, and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, a DVD, any other optical medium, any other physical medium with patterns of marks or holes, RAM, a PROM, an EPROM, an EEPROM, a FLASHEPROM, any other memory chip or cartridge, or any other medium which can be read by a computer.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art. For example, this description describes the technology in the context of an Internet service in conjunction with a DNS resolver. It will be appreciated by those skilled in the art that functionalities and method steps that are performed by a DNS resolver may be performed by an Internet service. One skilled in the art will recognize that the Internet service may be configured to provide Internet access to one or more computing devices that are coupled to the Internet service, and that the computing devices may include one or more processors, buses, memory devices, display devices, I/O devices, and the like. Furthermore, those skilled in the art may appreciate that the Internet service may be coupled to one or more databases, repositories, servers, and the like, which may be utilized in order to implement any of the embodiments of the invention as described herein. One skilled in the art will further appreciate that the term “Internet content” comprises one or more of web sites, domains, web pages, web addresses, hyperlinks, URLs, any text, pictures, and/or media (such as video, audio, and any combination of audio and video) provided or displayed on a web page, and any combination thereof.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

From the foregoing, it will be appreciated that specific embodiments of the system have been described herein for purposes of illustration, but that various modifications may be made without deviating from the spirit and scope of the system. Accordingly, the system is not limited except as by the appended claims.

What is claimed is:

1. A computer-implemented method for anonymization of personal data, the method comprising:
receiving from a user a domain name address associated with an intended website and an Internet Protocol (IP) address associated with the user; and
encrypting the IP address associated with the user by translating the IP address into a unique identifier, the encryption being a one-way hashing process.

2. The computer-implemented method of claim 1, further comprising:
sending the unique identifier and the domain name address to a third party;
receiving, from the third party, the unique identifier and a third party content, the third party content being based on the domain name;
associating the third party content with the IP address; and
based on the IP address, providing the third party content to the user.

3. The computer implemented method of claim 1, wherein the requested domain name address is an invalid domain name.

4. The computer-implemented method of claim 1, wherein the request is received within an Internet Server Provider (ISP) network associated with the user.

5. The computer-implemented method of claim 3, wherein the third party is located outside the ISP network.

6. The computer-implemented method of claim 1, wherein the invalid domain name is a mistyped valid domain name or a mal-formed domain name.

7. The computer-implemented method of claim 1, further comprising providing the user with an option page that provides a mechanism to the user to opt in to receiving the third party content.

8. The computer-implemented method of claim 6, wherein a record is placed on a system associated with the user to indicate that the user opted to receive the third party content.

9. The computer-implemented method of claim 6, further comprising providing the user with a non-existent page error message based on a user request to not receive the third party content.

10. The computer-implemented method of claim 1, wherein the third party content is an advertisement.

11. A system for anonymization of personal data, the system comprising:
a communication module to receive from a user a domain name address associated with an intended website and an Internet Protocol (IP) address associated with the user; and
a compliance server to encrypt the IP address associated with the user by translating the IP address into a unique identifier via a one-way hashing process.

12. The system of claim 11, wherein the compliance server is used further to:
send the unique identifier and the domain name address to a third party,
receive from the third party the unique identifier and a third party content, the third party content being based on the domain name; and
associate the third party content with the IP address, and
based on the IP address, provide the third party content to the user.

13. The system of claim 11, wherein the requested domain name address is an invalid domain name.

14. The system of claim 11, wherein the request is received within an Internet Server Provider (ISP) network associated with the user.

15. The system of claim 11, wherein the third party is located outside the ISP network.

16. The system of claim 11, wherein the invalid domain name is a mistyped valid domain name or a mal-formed domain name.

17. The system of claim 11, wherein the communication module further provides the user with an option page that provides a mechanism to the user to opt in to receiving the third party content.

18. The system of claim 17, wherein a record is placed on a system associated with the user to indicate that the user opted to receive the third party content.

19. The system of claim 17, wherein the communication module is used to provide the user with a non-existent page error message based on a user request not to receive the third party content.

20. The system of claim 11, wherein the third party content is an advertisement.

21. The system of claim 11, wherein the encryption is based on predetermined parameters.

22. A computer readable storage medium having a program embodied thereon, the program executable by a processor in a computing device to perform a method anonymization of personal data, the method comprising:
receiving, from the user, a domain name address associated with an intended website and an Internet Protocol (IP) address associated with the user;
determining that the domain name address is an invalid domain name;
encrypting the IP address associated with the user by translating the IP address into a unique identifier, the encryption being a one-way hashing process;
sending the unique identifier and the invalid domain name address to the third party;
receiving, from the third party, the unique identifier and a third party content, the third party content being based on the invalid domain name;
decrypting the unique identifier by translating the unique identifier back into the IP address;
associating the third party content with the IP address; and
based on the IP address, providing the third party content to the user.
